(19) United States
(12) Patent Application Publication
(10) Pub. No.: US 2026/0110215 A1
(43) Pub. Date: Apr. 23, 2026

(54) MODULATOR AND VERTICAL LOUVRE BLIND HAVING MODULATOR

(71) Applicant: UNION WINNER INTERNATIONAL CO., LTD., TAIPEI CITY (TW)

(72) Inventor: Ming-Tsung PAI, CAOTUN TOWNSHIP (TW)

(73) Assignee: UNION WINNER INTERNATIONAL CO., LTD., TAIPEI CITY (TW)

(21) Appl. No.: 19/020,541

(22) Filed: Jan. 14, 2025

(30) Foreign Application Priority Data
Oct. 23, 2024 (TW) 113211495

(51) Int. Cl. E06B 9/36

(52) U.S. Cl. CPC E06B 9/361; E06B 9/364

(57) ABSTRACT

A modulator for a vertical louvre blind includes a case, a top cap, a transmission member, and a connector. The case has an encircling wall, a first axial hole, a bottom wall, and an accommodating space. The transmission member is accommodated in the accommodating space. An end of the transmission member is connected to the connector. The top cap is detachably disposed at the top side of the case, and has a base and a lateral plate formed at one side of the base. The lateral plate is formed with a horizontally extending section on the periphery of the base and further extends downwardly to be formed with a downwardly extending section. The horizontally extending section and the downwardly extending section collectively form a positionally limiting area to positionally limit the encircling wall, making the top cap strengthen the structure of the encircling wall of the case.

### BACKGROUND OF THE INVENTION

### 1. Field of the Invention

The present invention relates to vertical louvre blinds and more particularly, to a modulator for adjusting the slat angle, which uses the structure of a top cap to stabilize a case of the modulator to prevent the case from deformation and disintegration because of the slat angle being adjusted to the limit position.

### 2. Description of the Related Art

A louvre blind is composed of many vertical blind slats or horizontal blind slats. The operator uses a modulator to control the tilt angle of all blind slats, so as to adjust the amount of light entering the room and also keep certain privacy. Therefore, louvre blinds are widely used in offices or homes. The modulator of the louvre blind can adjust the tilt angle of the blind slats through the combination of a worm rod and a worm wheel. China U.S. Pat. No. 201,027,484 Y disclosed a louvre blind transmission device, wherein the worm wheel and the worm rod are driven by a pulley and a traction rope, and then the operation force is transmitted to a ladder rope connected with the blind slats through a transmission shaft, so that the blind slats can be raised, lowered or turned to achieve light adjusting effect.

The tilt angle of the blind slats of the louvre blind has a certain limit. If the tilt angle of the blind slats reaches the limit position, the blind slats and the transmission shaft are all unable to be rotated anymore. In this status, if the operator continues operating the modulator, the force of the worm rod and the worm wheel cannot be transmitted, so that the worm rod and the worm wheel will be disengaged and push outward to cause the case deformation and disintegration, resulting in the whole modulator breaking away and being useless. If the situation is serious, it may cause chipped tooth to the worm rod and the worm wheel. China U.S. Pat. No. 215,443,861 U disclosed a window blind modulating device, wherein an opening of a bottom case is closed by a covering plate, and positionally limiting hooks formed at two sides of the covering plate are abutted against lateral walls at two sides of the bottom case. When the worm rod and the worm wheel generate outward pushing force, the covering plate restricts the position of the lateral walls, preventing the lateral walls from deformation.

However, this covering plate needs to be provided at two sides thereof with the positionally limiting hooks, that is relatively more complicated in structure. Besides, the positionally limiting hooks only simply cover two lateral walls of the bottom case, that is limited in stabilizing effect. After long-term use, the pushing force of the worm rod and the worm wheel is still liable to cause the lateral walls deformation. Therefore, the inventor made effort to think about how to provide a structure for improving the strength of the case of the modulator, preventing the modulator from damage caused by inappropriate operation.

### SUMMARY OF THE INVENTION

In view of the above description that the existing louvre blind modulators have many shortcomings, it is an objective of the present invention to provide a structure of a modulator, which has a top cap located at the inner side and the outer side of the case to achieve case clamping effect, effectively improving the firmness of the case for preventing the case from deformation and disintegration.

To attain the above objective, the present invention provides a modulator which includes a case having an encircling wall, a first axial hole penetrating through the encircling wall, a bottom wall provided at the bottom side of the encircling wall, and an accommodating space formed in the encircling wall and the bottom wall; a top cap detachably disposed at the top side of the case, the top cap having a base and a lateral plate formed at one side of the base, the lateral plate being formed with a horizontally extending section on the periphery of the base and further extending downwardly to be formed with a downwardly extending section so that the horizontally extending section and the downwardly extending section of the lateral plate collectively form a positionally limiting area to positionally limit the encircling wall of the case; a transmission member accommodated in the accommodating space of the case; and a connector connected to an end of the transmission member.

Preferably, the base of the top cap of the modulator is formed at the bottom side thereof with a thick bottom section. The thick bottom section can cooperate with the downwardly extending section to fix the encircling wall of the case in a clamping manner.

Preferably, the lateral plate of the top cap of the modulator further has two upwardly extending sections. The two upwardly extending sections are formed at two ends of the horizontally extending section of the lateral plate and located at the top side of the horizontally extending section. The upwardly extending sections can increase the structural thickness of the lateral plate, so as to improve the structural strength of the top cap.

Preferably, the base of the top cap of the modulator is formed at the top side thereof with at least one concave portion. The concave portion can improve the structural strength of the top cap and make the top cap have a little elasticity, so that when the top cap or the encircling wall of the case is pushed, there is flexible space for resisting the pushing force.

Preferably, the transmission member of the modulator is provided at an end thereof with a connecting portion and two buckle portions connected to the bottom end of the connecting portion. The connecting portion is provided with an open groove. A gap is formed between the two buckle portions. The connecting portion and the two buckle portions pass through the bottom wall of the case to be combined with the connector. The open groove and the gap make the connecting portion and the buckle portions have elasticity and compressible, not only facilitating the connection of the transmission member to the connector, but also using the open groove to make the connector idle when the modulator is overloaded.

Preferably, the transmission member of the modulator is provided at an end thereof with a connecting hole, and the connector is provided at an end thereof with a connecting portion and two buckle portions connected to the top end of the connecting portion. The connecting portion is provided with an open groove. A gap is formed between the two buckle portions. The connecting portion and the two buckle portions are inserted in and fixed to the connecting hole of the transmission member. The open groove and the gap make the connecting portion and the buckle portions have elasticity and compressible, not only facilitating the connection of the connector to the transmission member, but also using the open groove to make the connector idle when the modulator is overloaded.

Preferably, the width of the gap between the two buckle portions is larger than the width of the open groove of the connecting portion. By the width difference, when the connecting portion is compressed to the limit, the two buckle portions are still kept with a certain gap and will not separate from the connector.

Preferably, the encircling wall of the case of the modulator is provided at the top end thereof with a plurality of combining holes. The top cap further has a plurality of combining shafts formed at two ends of the base respectively. The plurality of combining shafts are inserted in the plurality of combining holes of the case respectively. The top cap is fixed to the case. As a result, the arrangement of the combining shafts and the combining holes can increase the firmness of the top cap on the case, preventing the top cap from opening because of being pushed by the transmission member.

Preferably, the encircling wall of the case is formed at the outer side thereof with two inserting rods. The two inserting rods enable the modulator to be firmly fixed to a blind slat fixer in the vertical louvre blind.

It is another objective of the present invention to provide a vertical louvre blind having the above-described modulator. The vertical louvre blind includes a top beam; a plurality of blind slat fixers movably disposed in the top beam, each of the blind slat fixers having a second axial hole penetrating through the blind slat fixer, a blind slat combining unit, and a blind slat main body connected with the blind slat combining unit; a modulator combined with one of the blind slat fixers, the modulator having a case, a top cap, a transmission member and a connector, the case having an encircling wall, a first axial hole penetrating through the encircling wall, a bottom wall provided at the bottom side of the encircling wall and an accommodating space formed in the encircling wall and the bottom wall, the accommodating space being configured to accommodate the transmission member, an end of the transmission member being connected to the connector, the top cap being detachably disposed at the top side of the case and having a base and a lateral plate formed at one side of the base, the lateral plate being formed with a horizontally extending section on the periphery of the base and further extending downwardly to be formed with a downwardly extending section so that the horizontally extending section and the downwardly extending section of the lateral plate collectively form a positionally limiting area to accommodate the encircling wall of the case; and a transmission shaft inserted through the second axial holes of the plurality of blind slat fixers and the first axial hole of the modulator and engaged with another end of the transmission member of the modulator.

By the above-described structural features, in the modulator of the present invention, the horizontally extending section and the downwardly extending section of the top cap make the top cap itself have relatively higher structural strength. The pushing force generated from the transmission member will be decentralized to the horizontally extending section and the downwardly extending section, so that the top cap is not prone to deformation, and the firmness of the case is also improved at the same time. In addition, the base of the top cap has the thick bottom section, and the lateral plate has the upwardly extending section. That primarily increase the thickness of the base and the lateral plate to achieve force decentralizing effect. Besides, the thick bottom section and the downwardly extending section are located at the inner side and the outer side of the encircling wall of the case respectively, collectively achieving the effect of clamping the encircling wall. When the encircling wall of the case is pushed by the transmission member, it can still maintain its position, prevented from deformation and disintegration.

### BRIEF DESCRIPTION OF THE DRAWINGS

FIG. 1 is a front view of a vertical louvre blind having a modulator of the present invention.

FIG. 2 is a perspective view of the vertical louvre blind having the modulator of the present invention without blind slat main body.

FIG. 3 is an exploded perspective view of the vertical louvre blind having the modulator of the present invention without blind slat main body.

FIG. 4 is a perspective view of the modulator of the present invention.

FIG. 5 is an exploded perspective view of the modulator of the present invention.

FIG. 6 is a sectional view of the modulator of the present invention, showing the relative relationship between a top cap and a case.

FIG. 7 is a sectional view taken along the line A-A in FIG. 6, showing the relative relationship between a transmission member and a connector.

FIG. 8 is an exploded perspective view of the modulator of the present invention, showing another embodiment of the transmission member and the connector.

### DETAILED DESCRIPTION OF THE INVENTION

First of all, it is to be mentioned that same or similar reference numerals used in the following embodiments and the appendix drawings designate same or similar elements or the structural features thereof throughout the specification for the purpose of concise illustration of the present invention. It should be noticed that for the convenience of illustration, the components and the structure shown in the figures are not drawn according to the real scale and amount, and the features mentioned in each embodiment can be applied in the other embodiments if the application is possible in practice. Besides, when it is mentioned that an element is disposed on another element, it means that the former element is directly disposed on the latter element, or the former element is indirectly disposed on the latter element through one or more other elements between aforesaid former and latter elements. When it is mentioned that an element is directly disposed on another element, it means that no other element is disposed between aforesaid former and latter elements.

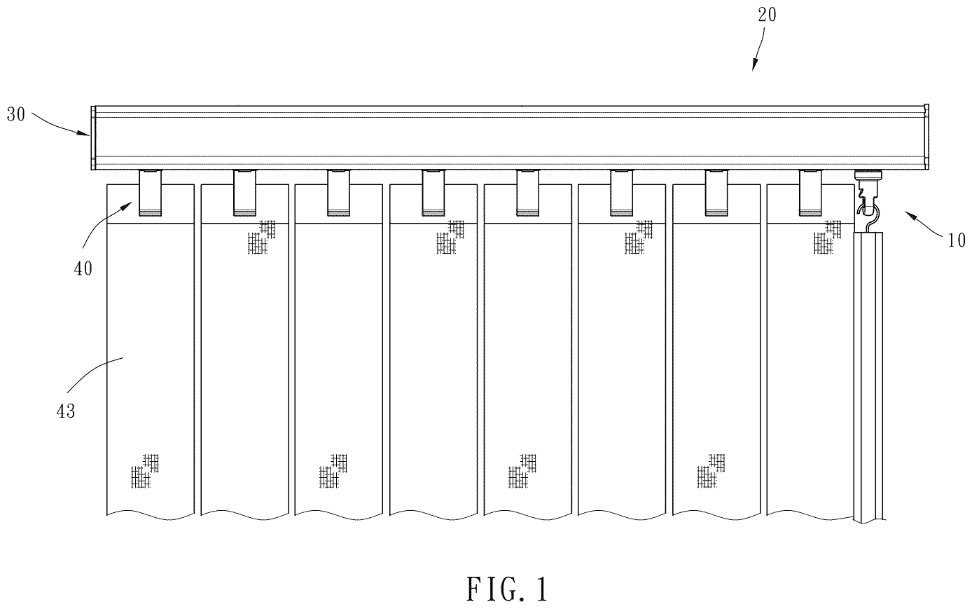

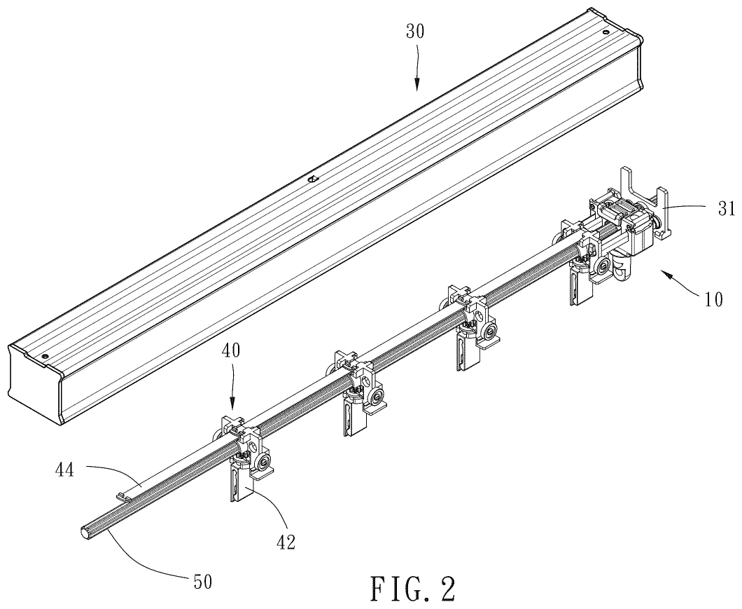

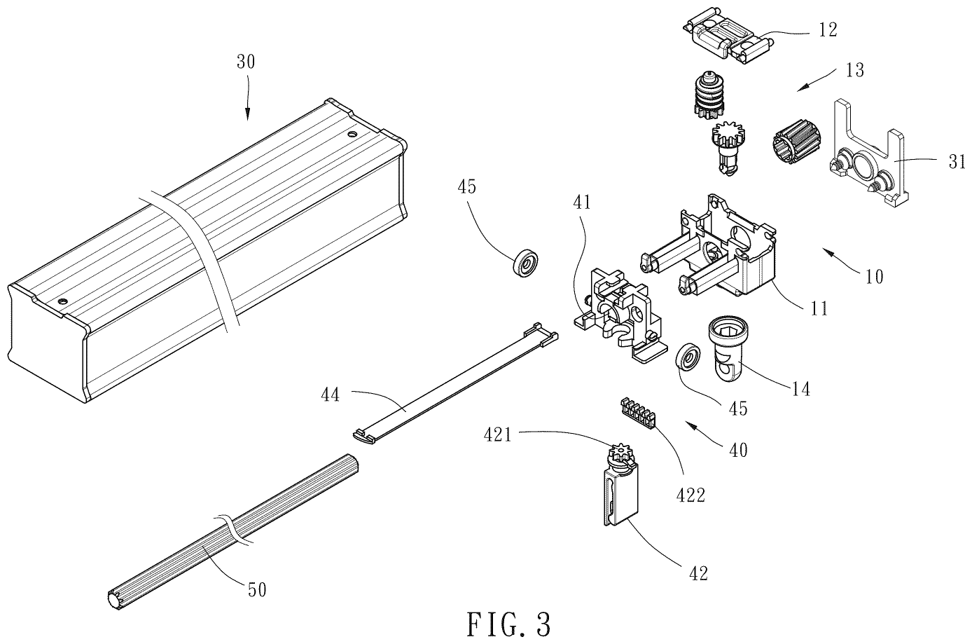

Referring to FIG. 1 to FIG. 3, an embodiment of a modulator 10 of the present invention being applied in a vertical louvre blind 20 is shown. The vertical louvre blind 20 primarily includes a top beam 30, a plurality of blind slat fixers 40, a modulator 10, and a transmission shaft 50. For the convenience of showing the overall structure, the top beam 30 is presented not covering other components in FIG. 2.

The top beam 30 is fixed to the wall with hanging members (not shown), and accommodates the plurality of blind slat fixers 40, the modulator 10 and the transmission shaft 50. The top beam 30 is provided therein with a spacer unit 31. Besides, in the top beam 30, the bottom side thereof is formed with groove tracks (not shown).

The amount of the blind slat fixers 40 depends on the width of the blind. Each blind slat fixer 40 has a second axial hole 41 penetrating through the blind slat fixer 40, a blind slat combining unit 42, and a blind slat main body 43 connected with the blind slat combining unit 42. The blind slat combining unit 42 is provided at the bottom side of the blind slat fixer 40, located below the second axial hole 41, and formed with the structure for clamping the blind slat main body 43 to fix an end of the blind slat main body 43. Above the clamping structure, there is a gear 421 and a rack 422 engaged with the gear 421. Through the mechanism of the gear 421 and the rack 422, the blind slat main body 43 is driven to turn. A blind slat fixer 40 is connected, through a connecting piece 44 at the top side thereof, to another blind slat fixer 40, and rollers 45 at two lateral sides are disposed on the groove tracks in the top beam 30. That enables the blind slat fixers 40 to move in the top beam 30, and spaces the blind slat main bodies 43 with a distance therebetween, so as to achieve relatively better light modulating effect.

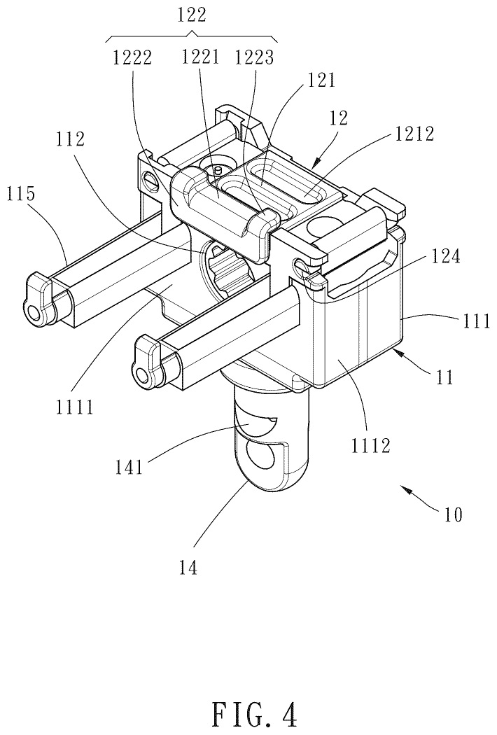

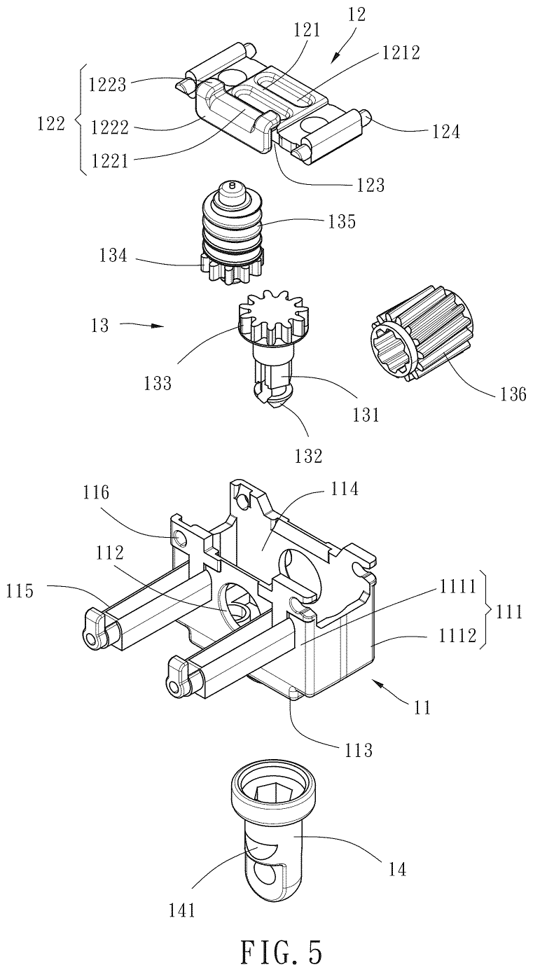

Referring to FIG. 4 and FIG. 5, the modulator 10 is disposed adjacent to an end of the top beam 30, and has a case 11, a top cap 12, a transmission member 13, and a connector 14. The case 11 has an encircling wall 111, a first axial hole 112 penetrating through the encircling wall 111, a bottom wall 113 provided at the bottom side of the encircling wall 111, and an accommodating space 114 formed in the encircling wall 111 and the bottom wall 113. The transmission member 13 is accommodated in the accommodating space 114. The case 11 in this embodiment is quadrilateral in shape, so the encircling wall 111 thereof is composed of four lateral walls, including two long lateral walls 1111 and two short lateral walls 1112. One of the long lateral walls 1111 is formed on the outer side thereof with two inserting rods 115. The case 11 is connected with the adjacent blind slat fixer 40 through the two inserting rods 115. The other long lateral wall 1111 is abutted on the spacer unit 31 of the top beam 30. In the condition that the width is relatively larger and the blind slat fixers 40 are all gathered at an end, the spacer unit 31 can prevent the transmission shaft 50 from deformation, for the arrangement of appropriate amount of blind slat fixers 40.

The top cap 12 of the modulator 10 has a base 121 and a lateral plate 122 formed at one side of the base 121, and is disposed at the top side of the case 11. The encircling wall 111 of the case 11 is provided at the top end thereof with four combining holes 116 at four corners respectively. The top cap 12 has combining shafts 124 formed at two ends of the base 121. The combining shafts 124 are inserted in the combining holes 116 of the encircling wall 111. Two of the combining holes 116 have openings. Therefore, the combining shafts 124 at an end of the top cap 12 are firstly inserted in the combining holes 116 having the openings to make the top cap 12 pivotally connected to the top end of the encircling wall 111. Then, the top side of the case 11 is covered with the top cap 12, and the combining shafts 124 at the other end of the top cap 12 is inserted into the other two combining holes 116, so that the connection of the top cap 12 with the case 11 is accomplished. As a result, the top cap 12 and the case 11 are combined through the combining shafts 124 and the combining holes 116. The two long lateral walls 1111 of the encircling wall 111 of the case 11 are fixed by the combining shafts 124 of the top cap 12 at the same time. When the two long lateral walls 1111 are pushed by the force from the inside of the case 11, the insertion of the combining shafts 124 in the combining holes 116 can prevent the top cap 12 from being lifted, so as to prevent the transmission member 13 in the case 11 from being pushed to the outside.

The lateral plate 122 of the top cap 12 is firstly formed with a horizontally extending section 1221 and then extends downwardly to be formed with a downwardly extending section 1222. In this way, when the top cap 12 is combined to the top side of the case 11, the lateral plate 122 of the top cap 12 form a positionally limiting area 123 to cover the long lateral wall 1111 of the encircling wall 111 formed with the two inserting rods 115. That positionally limits the long lateral wall 1111, preventing it from displacement, so that the long lateral wall 1111 of the encircling wall 111 is prevented from being pushed to open outwardly.

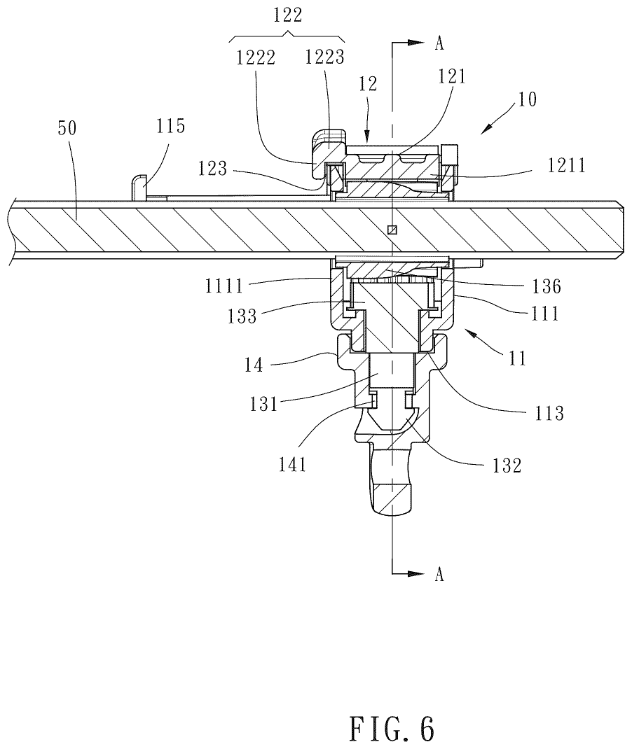

In addition, the base 121 of the top cap 12 is formed at the bottom side thereof with a thick bottom section 1211. The base 121 is formed at the top side thereof with at least one concave portion 1212. The lateral plate 122 of the top cap 12 further has two upwardly extending sections 1223. The two upwardly extending sections 1223 extend from two ends of the horizontally extending section 1221 upwardly. At this time, the thick bottom section 1211 of the base 121 is located at the inner side of the encircling wall 111 of the case 11, the horizontally extending section 1221 and the upwardly extending sections 1223 of the lateral plate 122 are located at the top rim of the encircling wall 111 of the case 11, and the downwardly extending section 1222 of the lateral plate 122 is located at the outer side of the encircling wall 111 of the case 11. The positionally limiting area 123 of the top cap 12 is formed by the thick bottom section 1211, the horizontally extending section 1221, the upwardly extending sections 1223 and the downwardly extending section 1222 collectively. The positionally limiting area 123 can accommodate the encircling wall 111 of the case 11, making the top cap 12 in the status that a single side thereof clamps one side (long lateral wall 1111) of the encircling wall 111, as shown in FIG. 6.

The structural strength of the top cap 12 is not only improved by the increased thickness of the base 121 and the structure formed with the upwardly extending sections 1223, but the structural strength of the top cap 12 is also improved by the concave portion 1212 of the base 121, such that the top cap 12 can bear relatively larger force. Wherein, the thickness of the thick bottom section 1211 is close to the thickness of the downwardly extending section 1222. In this embodiment, the thickness of the thick bottom section 1211 is larger than the thickness of the downwardly extending section 1222. In this way, the position of the encircling wall 111 is restricted in a way that one of the long lateral walls 1111 of the encircling wall 111 is clamped. When the encircling wall 111 receives the force from the inside of the case 11, the top cap 12 will prevent the long lateral wall 1111 of the encircling wall 111 from being pushed to open outwardly, so as to prevent the combining shafts 124 and the combining holes 116 from disintegration.

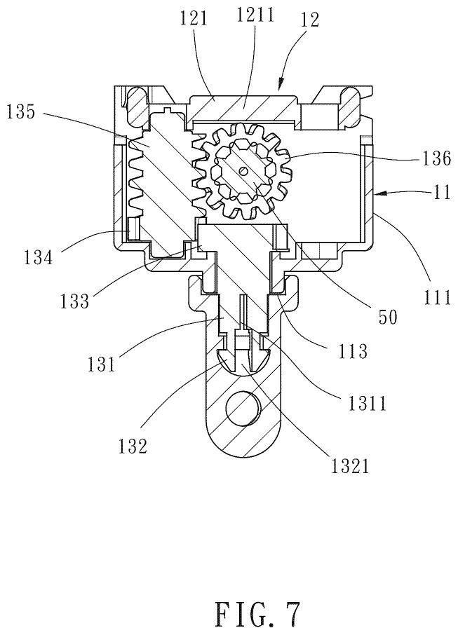

The transmission member 13 is provided at an end thereof with a connecting portion 131 and two buckle portions 132 connected to the bottom end of the connecting portion 131. The connecting portion 131 is provided at the center thereof with an open groove 1311. A gap 1321 is formed between the two buckle portions 132. The exterior shape of the connecting portion 131 is hexagon or other polygons. The connecting portion 131 and the two buckle portions 132 pass through the bottom wall 113 of the case 11 to be combined to the connector 14. The top end of the connector 14 is correspondingly formed with an internal hexagonal shape for being sleeved onto the connecting portion 131. Besides, the connector 14 is provided with a fastening hole 141 for the two buckle portions 132 to be inserted in the fastening hole 141 and buckled with the connector 14, as shown in FIG. 5 and FIG. 7. In addition, another end of the transmission member 13 is composed of an active gear 133, a driven gear 134, a worm rod 135 and a worm wheel 136. The active gear 133 is formed at the top side of the connecting portion 131. The active gear 133 is engaged with the driven gear 134. The driven gear 134 is connected to the worm rod 135. The worm rod 135 is engaged with the worm wheel 136. The worm wheel 136 is sleeved onto the transmission shaft 50, and the worm wheel 136 is formed on the inner surface thereof with internal teeth to be engaged with the transmission shaft 50.

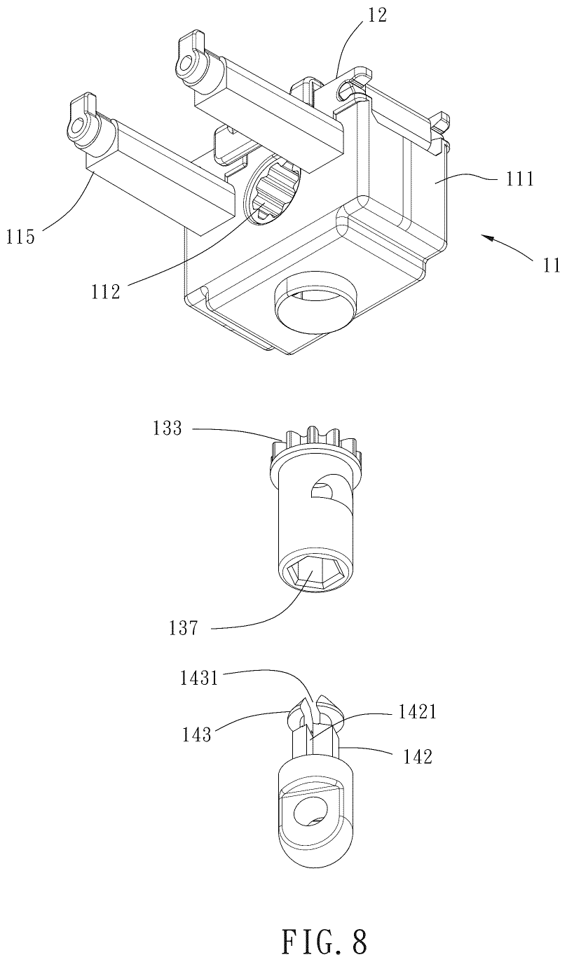

Referring to FIG. 8, for the convenience of illustration and avoiding confusion, only the active gear 133 of the transmission member 13 and the connector 14 are separated from other components in FIG. 8, because other components of the modulator 10 are not structurally different. The buckling structure between the transmission member 13 and the connector 14 may be exchanged. The transmission member 13 is formed at an end thereof with a connecting hole 137, and the connector 14 is provided at an end thereof with a connecting portion 142 and two buckle portions 143 connected to the top end of the connecting portion 142. The connecting portion 142 is provided at the center thereof with an open groove 1421. A gap 1431 is formed between the two buckle portions 143. The connecting portion 142 and the two buckle portions 143 of the connector 14 are inserted in and fixed to the connecting hole 137 of the transmission member 13.

The transmission shaft 50 is rotatably fastened in the top beam 30, and inserted through the second axial holes 41 of the blind slat fixers 40 and the first axial hole 112 of the modulator 10. The outer surface of the transmission shaft 50 has teeth structure or non-circular geometric structure for being engaged with the racks 422 of the blind slat combining units 42 of the blind slat fixers 40 and engaged with the worm wheel 136 of the transmission member 13 of the modulator 10.

Referring to FIG. 1 to FIG. 3 and FIG. 7, in practical use, the operator rotates a control wand connected with the modulator 10 to rotate the connector 14, the connecting portion 131 and the active gear 133 of the transmission member 13 of the modulator 10 at the same time. The active gear 133 drives the driven gear 134. The worm rod 135 connected with the driven gear 134 rotates and drives the worm wheel 136 to operate, so that the transmission shaft 50 engaged with the worm wheel 136 of the transmission member 13 starts to rotate and at the same time drive the racks 422 of the blind slat combining units 42 of the blind slat fixers 40, which are engaged with the transmission shaft 50. The racks 422 horizontally displace, driving the gears 421 of the blind slat combining units 42 to rotate, such that the tilt angle of the blind slat main bodies 43 is changed. The limit of the tilt angle of the blind slat main bodies 43 corresponds to the size of the racks 422.

When the blind slat main bodies 43 are rotated to the limit position, the racks 422 of the blind slat combining units 42 cannot displace in the same direction anymore, and the transmission shaft 50 is fixed and unable to rotate. The force of the operator rotating the control wand will be centralized at the transmission member 13 of the modulator 10, making the worm rod 135 start being tightly abutted against the worm wheel 136 and generate a pushing force. When the transmission member 13 cannot bear the force, the overloaded state is reached. The worm rod 135 will still continue displacing upwardly, and the worm wheel 136 will continue displacing toward the lateral side, thereby pushing the case 11 and the top cap 12 of the modulator 10. One side of the encircling wall 111 of the case 11 is abutted on an end of the inner side of the top beam 30, so the side will not be deformed by the pushing of the transmission member 13. The pushing force of the transmission member 13 is primarily transmitted to the two long lateral walls 1111 of the encircling wall 111 and the top cap 12.

First, the combining shafts 124 of the top cap 12 are inserted in the combining holes 116 of the case 11, that can prevent the top cap 12 from being lifted, so as to prevent the transmission member 13 in the case 11 from being pushed to the outside and disengaged. Second, when the top cap 12 cannot be lifted, the pushing force is transmitted to the long lateral walls 1111 of the encircling wall 111. However, the long lateral wall 1111 at one side of the encircling wall 111 is clamped by the lateral plate 122 and the base 121 of the top cap 12, as shown in FIG. 6. That can decentralize the outward stretching force of the encircling wall 111 to the thick bottom section 1211, the horizontally extending section 1221, the upwardly extending sections 1223 and the downwardly extending section 1222, thereby preventing the encircling wall 111 from outward stretching to cause the combining shafts 124 of the top cap 12 to separate from the combining holes 116 of the case 11. As a result, no matter the transmission member 13 generates upward or transverse force, the top cap 12 will restrict the position of the encircling wall 111 to improve the structural firmness of the case 11, so as to prevent the case 11 and the top cap 12 from separation and the resulting malfunction in modulation.

Besides, the width of the gap 1321 between the two buckle portions 132 of the transmission member 13 is larger than the width of the open groove 1311 of the connecting portion 131. This configuration design provides the modulator 10 an over-rotation resisting mechanism. When the blind slat main bodies 43 are rotated to the limit position, the force centralized at the transmission member 13 of the modulator 10 is transmitted to the connecting portion 131 and the two buckle portions 132. Because of having the open groove 1311, the connecting portion 131 is pushed inwardly and compressed. At this time, the connecting portion 131 is separated from the top end of the connector 14, making the connector 14 in the idling state. Because of the gap 1321, the two buckle portions 132 also approach each other. However, the width of the gap 1321 between the two buckle portions 132 is relatively larger. Therefore, after the open groove 1311 of the connecting portion 131 is compressed to the limit, the two buckle portions 132 will not be compressed anymore. At this time, the two buckle portions 132 have not been compressed to the extent making the two buckle portions 132 separate from the connector 14. As a result, the action of the connecting portion 131 being compressed can directly counteract the force centralized at the transmission member 13. Even though the operator continues rotating the control wand, it only brings the idling state and the associated sound, so that the over-rotation resisting mechanism is achieved. The force cannot be transmitted to the worm rod 135 and the worm wheel 136 of the transmission member 13, that also prevent the worm rod 135 and the worm wheel 136 from being overloaded to push the case 11 and the top cap 12.

In conclusion, compared with the existing technology, in the modulator provided by the present invention, the top cap 12 is combined to the case 11, and the configuration design of the lateral plate 122 and the base 121 of the top cap 12 restricts the position of one side of the encircling wall 111 of the case 11. The position of the encircling wall 111 is restricted by the top cap 12, so that the outward stretching force of the encircling wall 111 is hard to push the top cap 12 to separate from the case 11. That effectively improves the firmness of the case 11 of the modulator 10.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A modulator, which is applied in a vertical louvre blind, the modulator comprising:
a case having an encircling wall, a first axial hole penetrating through the encircling wall, a bottom wall provided at a bottom side of the encircling wall, and an accommodating space formed in the encircling wall and the bottom wall;
a top cap detachably disposed at a top side of the case, the top cap having a base and a lateral plate formed at one side of the base, the lateral plate being formed with a horizontally extending section on a periphery of the base and further extending downwardly to be formed with a downwardly extending section so that the encircling wall of the case is positionally limited by the horizontally extending section and the downwardly extending section of the lateral plate;
a transmission member accommodated in the accommodating space of the case; and
a connector connected to an end of the transmission member.

2. The modulator as claimed in claim 1, wherein the base of the top cap of the modulator is formed at a bottom side thereof with a thick bottom section.

3. The modulator as claimed in claim 2, wherein the lateral plate of the top cap of the modulator further has two upwardly extending sections; the two upwardly extending sections are formed at two ends of the horizontally extending section and located at a top side of the horizontally extending section.

4. The modulator as claimed in claim 3, wherein the base of the top cap of the modulator is formed at a top side thereof with at least one concave portion.

5. The modulator as claimed in claim 1, wherein the transmission member of the modulator is provided at an end thereof with a connecting portion and two buckle portions connected to a bottom end of the connecting portion; the connecting portion is provided with an open groove; a gap is formed between the two buckle portions; the connecting portion and the two buckle portions pass through the bottom wall of the case to be combined with the connector.

6. The modulator as claimed in claim 1, wherein the transmission member of the modulator is provided at an end thereof with a connecting hole; the connector is provided at an end thereof with a connecting portion and two buckle portions connected to a top end of the connecting portion; the connecting portion is provided with an open groove; a gap is formed between the two buckle portions; the connecting portion and the two buckle portions are inserted in and fixed to the connecting hole of the transmission member.

7. The modulator as claimed in claim 6, wherein a width of the gap between the two buckle portions is larger than a width of the open groove of the connecting portion.

8. The modulator as claimed in claim 5, wherein a width of the gap between the two buckle portions is larger than a width of the open groove of the connecting portion.

9. The modulator as claimed in claim 1, wherein the encircling wall of the case of the modulator is provided at a top end thereof with a plurality of combining holes; the top cap further has a plurality of combining shafts formed at two ends of the base respectively; the plurality of combining shafts are inserted in the plurality of combining holes of the case respectively to make the top cap fixed to the case.

10. The modulator as claimed in claim 1, wherein the encircling wall of the case is formed at an outer side thereof with two inserting rods.

11. A vertical louvre blind comprising:
a top beam;
a plurality of blind slat fixers movably disposed in the top beam, each of the blind slat fixers having a second axial hole penetrating through the blind slat fixer, a blind slat combining unit, and a blind slat main body connected with the blind slat combining unit;
a modulator combined with one of the blind slat fixers, the modulator having a case, a top cap, a transmission member and a connector, the case having an encircling wall, a first axial hole penetrating through the encircling wall, a bottom wall provided at a bottom side of the encircling wall and an accommodating space formed in the encircling wall and the bottom wall, the accommodating space being configured to accommodate the transmission member, an end of the transmission member being connected to the connector, the top cap being detachably disposed at a top side of the case and having a base and a lateral plate formed at one side of the base, the lateral plate being formed with a horizontally extending section on a periphery of the base and further extending downwardly to be formed with a downwardly extending section so that the horizontally extending section and the downwardly extending section of the lateral plate collectively form a positionally limiting area to positionally limit the encircling wall of the case; and
a transmission shaft inserted through the second axial holes of the plurality of blind slat fixers and the first axial hole of the modulator, and engaged with another end of the transmission member of the modulator.

12. The vertical louvre blind as claimed in claim 11, wherein the base of the top cap of the modulator is formed at a bottom side thereof with a thick bottom section.

13. The vertical louvre blind as claimed in claim 12, wherein the lateral plate of the top cap of the modulator further has two upwardly extending sections; the two upwardly extending sections are formed at two ends of the horizontally extending section and located at a top side of the horizontally extending section.

14. The vertical louvre blind as claimed in claim 13, wherein the base of the top cap of the modulator is formed at a top side thereof with at least one concave portion.

15. The vertical louvre blind as claimed in claim 11, wherein the transmission member of the modulator is provided at an end thereof with a connecting portion and two buckle portions connected to a bottom end of the connecting portion; the connecting portion is provided with an open groove; a gap is formed between the two buckle portions; the connecting portion and the two buckle portions pass through the bottom wall of the case to be combined with the connector.

16. The vertical louvre blind as claimed in claim 11, wherein the transmission member of the modulator is provided at an end thereof with a connecting hole; the connector is provided at an end thereof with a connecting portion and two buckle portions connected to a top end of the connecting portion; the connecting portion is provided with an open groove; a gap is formed between the two buckle portions; the connecting portion and the two buckle portions are inserted in and fixed to the connecting hole of the transmission member.

17. The vertical louvre blind as claimed in claim 16, wherein a width of the gap between the two buckle portions is larger than a width of the open groove of the connecting portion.

18. The vertical louvre blind as claimed in claim 15, wherein a width of the gap between the two buckle portions is larger than a width of the open groove of the connecting portion.

19. The vertical louvre blind as claimed in claim 11, wherein the encircling wall of the case of the modulator is provided at a top end thereof with a plurality of combining holes; the top cap further has a plurality of combining shafts formed at two ends of the base respectively; the plurality of combining shafts are inserted in the plurality of combining holes of the case respectively to make the top cap fixed to the case.
